(19) United States
(12) Patent Application Publication
(10) Pub. No.: US 2010/0293330 A1
(43) Pub. Date: Nov. 18, 2010

(54) DISPLAYING TRANSITION IMAGES DURING A SLIDE TRANSITION

(75) Inventors: Christopher Michael Maloney, Mountain View, CA (US); Daly Chang, Sunnyvale, CA (US); Esther Ho, Cupertino, CA (US); Jason Zhao, San Jose, CA (US); Mark Pearson, Renton, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/466,125

(22) Filed: May 14, 2009

(51) Int. Cl. G06F 3/048; G06F 12/08

(52) U.S. Cl. 711/118; 715/732; 711/E12.017

(57) ABSTRACT

One or more transition images are displayed during a transition period between a display of slides within a presentation. The displayed transition images include images of different slides that are contained within the presentation. The transition images provide the audience with a glimpse of slides that are displayed within the presentation. For example, the transition images may include images from previous and future slides that are contained within the presentation. The transition images may also be cached in order to more efficiently display the transition images during the transition period.

### BACKGROUND

Many individuals and businesses prepare and deliver presentations using a computer presentation program. Typically, presentation programs provide a user with a graphical user interface that allows the user to edit, create, and present slides. During the presentation of the slides, each slide within the presentation is typically shown in the order that is specified when the presentation is created. A user may also navigate directly between any of the slides within the presentation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Transition images are displayed during a transition period between a display of slides within a presentation. The displayed transition images include images of different slides that are contained within the presentation. The transition images may provide the audience with a glimpse of slides that are displayed within the presentation. For example, the transition images displayed during a transition period may include images from previous and future slides that are contained within the presentation. The transition images may also be cached in order to more efficiently display the transition images during the transition period.

### BRIEF DESCRIPTION OF THE DRAWINGS

FIG. 1 illustrates an exemplary computing architecture for a computer;

FIG. 2 shows a multi-slide transition system;

FIG. 3 illustrates a caching scheme for caching transition images;

FIG. 4 shows a process for presenting transition images during a slide transition period;

FIG. 5 illustrates a process for caching transition images; and

FIG. 6 shows exemplary transition concepts, in accordance with aspects of the present invention.

### DETAILED DESCRIPTION

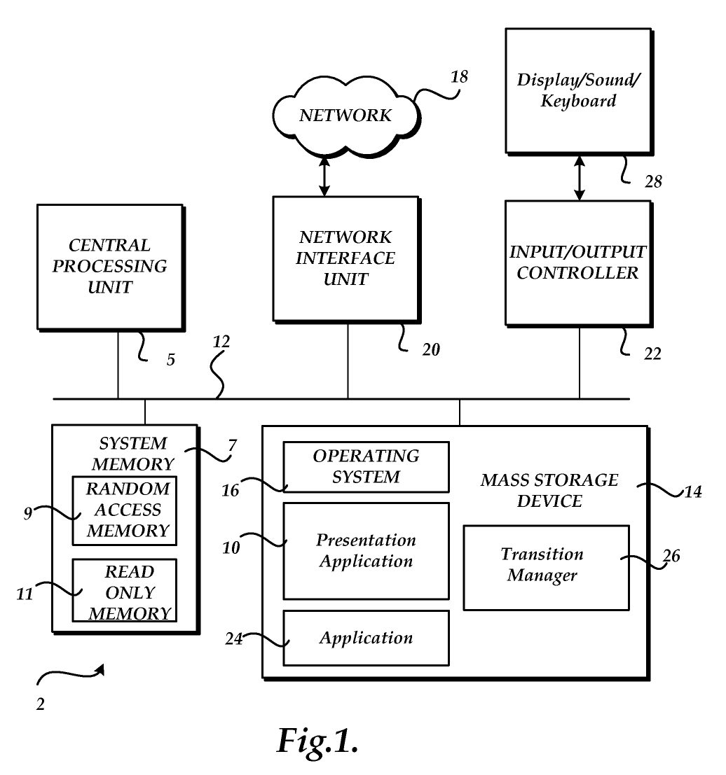

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer 2 utilized in the various embodiments will be described. The computer architecture as shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 also includes an input/output controller 22 for receiving and processing input from a number of devices, such as: a keyboard, mouse, speech recognizer, electronic stylus and the like (28). Similarly, the input/output controller 22 provides output to devices such as: a display screen, a printer, or some other type of device (28).

As mentioned briefly above, a number of program modules and data files may be stored in the mass storage device 14 and RAM 9 of the computer 2, including an operating system 16 suitable for controlling the operation of a networked personal computer, such as the VISTA® operating system from MICROSOFT CORPORATION of Redmond, Wash. The mass storage device 14 and RAM 9 may also store one or more program modules. In particular, the mass storage device 14 and the RAM 9 may store a presentation application 10. The presentation application 10 is operative to provide functionality for providing presentations. According to one embodiment of the invention, the presentation application 10 is the POWERPOINT® presentation application from MICROSOFT CORPORATION. Other presentation applications from other manufacturers may also be utilized.

The presentation application 10 utilizes a transition manager 26 to assist in providing a display of transition images between slides within a presentation. As will be described in greater detail below, the transition manager 26 instructs presentation application 10 to display transition images that provide a glimpse of slides within the presentation during a transition period between the display of slides. Additional details regarding the operation of the transition manager 26 will be provided below.

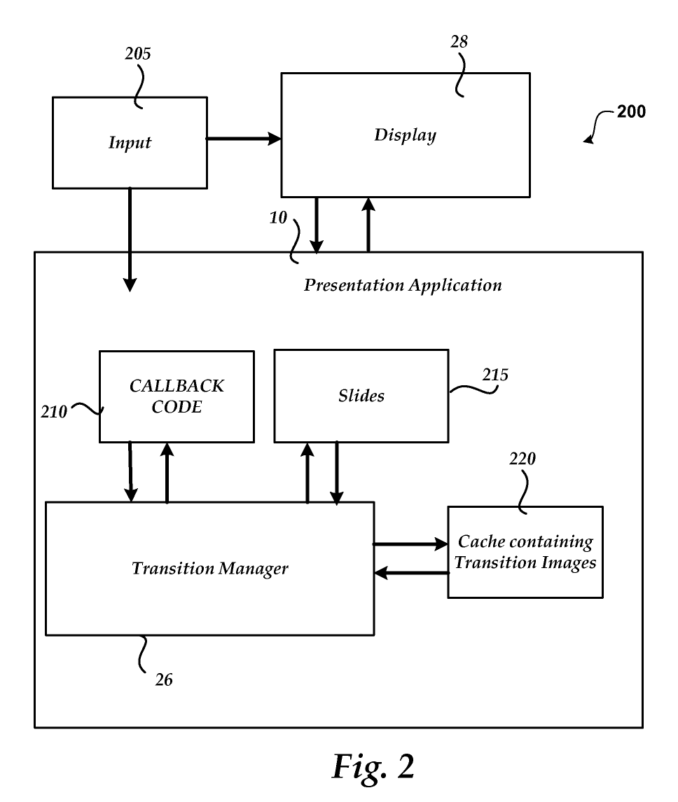

FIG. 2 illustrates a multi-slide transition system 200, in accordance with aspects of the invention. As illustrated system 200 includes presentation application 10, callback code 210, slides 215, cache 220, transition manager 26, input 205 and display 28. Transition manager 26 may be implemented within presentation application 10 as shown in FIG. 2 or may be implemented externally from application 10 as shown in FIG. 1.

As described briefly above, transition manager 26 provides for a display of transition images during a transition period that occurs between the display of slides 215 within a presentation. The displayed transition images include images of different slides that are contained within the presentation. The transition images provide the audience with a glimpse of slides that are displayed within the presentation. For example, the transition images may include images from previous and future slides that are contained within the presentation. The transition images may also be cached within cache 220, or some other memory, in order to more efficiently display the transition images during the transition period. According to one embodiment, cache 220 is configured to store a portion of the transition images for the slides within the presentation. According to another embodiment, cache 220 is configured to store a transition image for each slide within the presentation. Additionally, cache 220 may store transition images of varying resolution. For example, transition images relating to slides that are farther away in display order from a current slide may be stored at a lower resolution.

In order to facilitate communication with the transition manager 26, one or more callback routines, illustrated in FIG. 2 as callback code 210, may be implemented. Through the use of the callback code 210, the transition manager 26 may query for additional information used in providing the display of the transition images. For example, transition manager 26 may request to be informed when a transition indication is made to move between slides within a presentation. Other information may also be provided including, but not limited to information regarding: the current slide being displayed within the presentation; a time for the transition period; and the currently cached slides that may be used in displaying the transition images during a transition period between the display of slides within the presentation.

In response to receiving a transition indication, the transition manager 26 instructs presentation application 10 to display selected transition images during the transition period. This transition indication may result from an input 205 which may be come from many different sources, such as a keyboard, a mouse, a speech recognizer, and the like. The transition indication may also come directly from the presentation program. For example, a slide transition may automatically occur at predetermined intervals. Generally, any time a current slide within a presentation is changed to display another slide within the presentation a transition indication is provided to transition manager 26. According to one embodiment, the transition period is configurable. For example, the transition period may be set to three seconds, five seconds, ten seconds, and the like. The transition period may also be configured based on the selected transition concept.

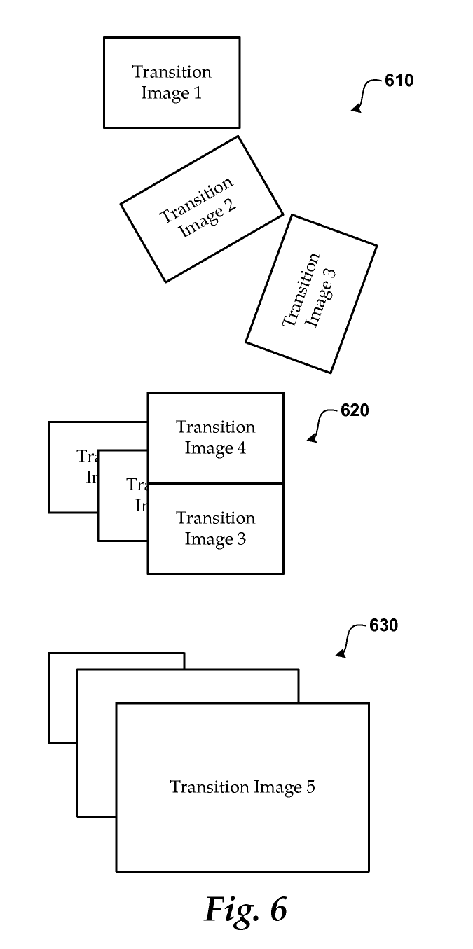

According to one embodiment, the selected images relate to a predetermined number of slides immediately before and after the current slide. The selected images may also relate to a transition concept that is used during the transition (See FIG. 6 and related discussion). Generally, a transition concept is a method of displaying transition images during the transition period. For example, a transition concept may relate to displaying an animation of images wherein the transition images appear to be falling away from a user.

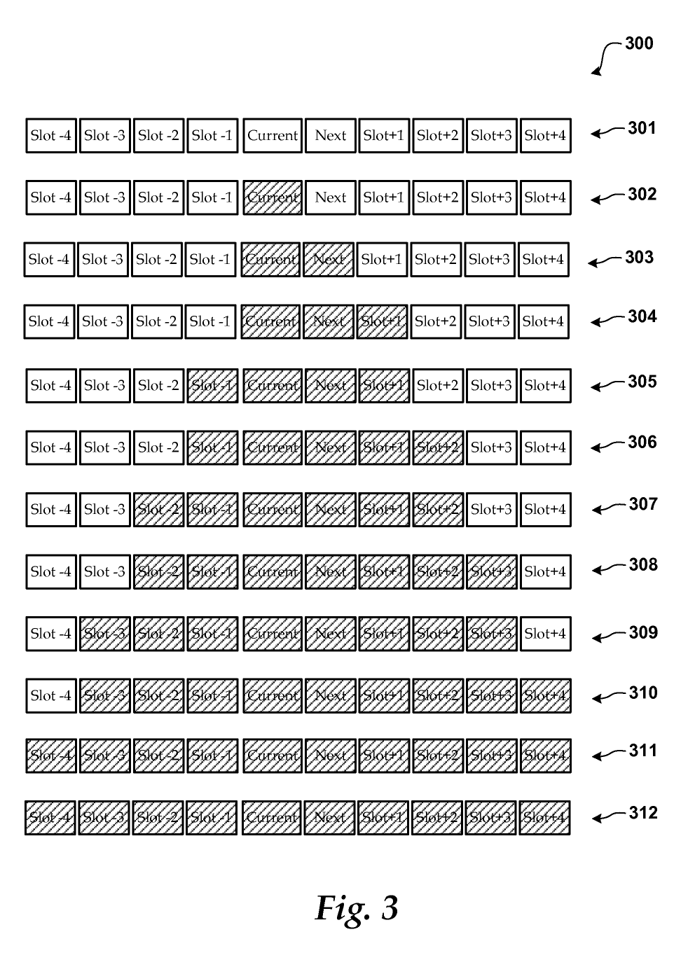

FIG. 3 shows a caching scheme for caching transition images. As illustrated caching scheme 300 shows different states (301-312) for a cache that contains transition images. According to one embodiment of the invention, the transition images are images of slides within the presentation. The transition images may include other content. For example, the transition images may comprise images of more than one slide within a single transition image. The transition images may also contain other images in addition to images of the slides within the presentation.

Initially, at caching step 301 no transition images are stored within the cache. According to one embodiment, transition images of slides within the presentation are not cached until a presentation is started. Alternatively, one or more transition images of the slides may be cached upon opening a presentation.

Caching step 302 illustrates caching an image of the current slide upon starting a presentation. Caching step 303 illustrates caching an image of the next slide after caching the current slide. The caching process continues until a predetermined number of transition images of the slides are cached and/or until the cache is full. Caching step 304 illustrates caching an image of the slide that is two slides in advance of the current slide. Caching step 305 illustrates caching an image of the slide that is one slide before the current slide. At this point in the caching process four transition images are cached. Caching step 306 illustrates caching an image of the slide that is three slides in advance of the current slide. Caching step 307 illustrates caching an image of the slide that is two slides before the current slide. Caching step 308 illustrates caching an image of the slide that is four slides in advance of the current slide. Caching step 309 illustrates caching an image of the slide that is three slides before the current slide. Caching step 310 illustrates caching an image of the slide that is five slides in advance of the current slide. Caching step 311 illustrates caching an image of the slide that is four slides before the current slide. Caching step 312 illustrates that the cache is full. While a specific order is illustrated in the caching scheme, other orderings may be utilized in other embodiments. For example, the caching scheme may start on a transition image for the current slide and advance sequentially through the slides until all of the transition images have been created and cached. Additionally, while only ten transition images are illustrated as cached, a different number of transition images may be cached. Generally, the number of cached transition images is determined in response memory and computational resources. Another factor that may be used in determining a number of transition images to cache is a selected transition concept. For example, during the transition period a transition concept utilizing twelve transition images may be applied to the display of the transition images. In this case, a cache size of at least twelve may be desired.

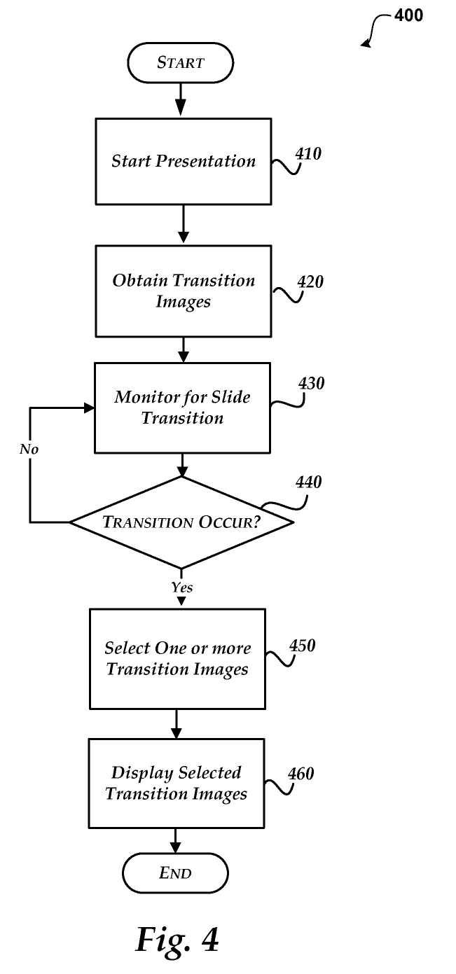

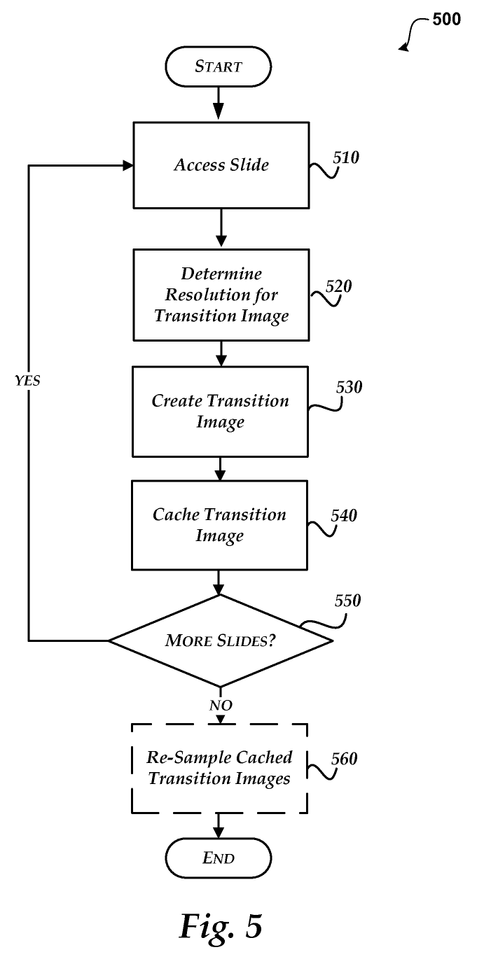

Referring now to FIGS. 4 and 5, an illustrative process for displaying transition images during a slide transition will be described. Although the embodiments described herein are presented in the context of a transition manager 26 and a presentation application 10, other types of application programs may be utilized. For instance, the embodiments described herein may be utilized within photo presentation program, and the like.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 4 shows a process for presenting transition images during a slide transition period. After a start operation, the process moves to operation 410, where a presentation is started. According to one embodiment, a user selects to begin a slide presentation within a presentation application.

Moving to operation 420, transition images are obtained. According to one embodiment, a transition image is created for each slide within the presentation. According to other embodiments, transition images may include more content than the image of the slide, less content than image from the slide; include other information within the transition image, and the like. Generally, the transition image is used to provide a user with an overview of slides that are presented near the current slide.

Flowing to operation 430, the process monitors for a slide transition. A slide transition occurs whenever an indication is received to move from one slide within the presentation to another slide within the presentation. For example, this may include moving from a current slide to a next slide within the presentation. This transition could also occur when moving from a current slide to any of the other slides within the presentation.

Transitioning to decision block 440, a determination is made as to whether a transition has occurred. When a transition has not occurred, the process returns to monitoring at operation 430. When a transition has occurred, the process moves to operation 450.

At operation 450, one or more of the transition images is selected for display. According to one embodiment at least two transition images are selected for display. For example, a transition image of the slide immediately before the current slide and the transition image of the slide immediately after the next slide may be selected. According to another embodiment, the number of transition images selected is based on a transition concept selected.

Flowing to operation 460, the selected transition images are displayed during the transition period.

The process then moves to an end operation and returns to processing other actions.

FIG. 5 illustrates a process for caching transition images within a presentation.

After a start operation, the process flows to operation 510, where a slide is accessed within a presentation. Generally, the caching process begins when a presentation is started and a first slide is accessed. According to another embodiment, the caching process may begin at another time, such as when the presentation is first accessed within a presentation application.

Moving to operation 520, a resolution at which to create the transition image is determined. According to one embodiment, the transition images correspond to the screen resolution of the display for the presentation. According to another embodiment, the resolution may change based on how far the accessed slide is from a current slide that is being displayed. For example, when the accessed slide is two slides away in display order from the current slide, the resolution may be set to half-resolution, or some other resolution.

Flowing to operation 530, a transition image of the slide is created. According to one embodiment, the transition image is an image of the accessed slide. According to another embodiment, the transition image is a compilation of the accessed slides and other slides. According to yet other embodiments, the transition image may comprise portions of the accessed slide as well as other information related to the presentation.

Transitioning to operation 540, the transition image is created having the desired content at the determined resolution.

Moving to operation 540, the transition image is cached. According to one embodiment, a portion of the transition images for the slides within the presentation are cached. According to another embodiment, all of the transition images are cached.

At decision operation 550, a determination is made as to whether there are any more slides within the presentation that have not had transition images cached. When there are more slides, the process returns to operation 510. When there are no more slides to cache, the process flows to optional operation 560 where the cached transition images may be re-sampled at different resolutions depending on their display distance from a current slide that is being displayed.

The process then moves to an end operation and returns to processing other actions.

FIG. 6 shows exemplary transition concepts. As illustrated, three different transition concepts are briefly shown including a wheel transition concept 610, a stacking transition concept 620, and a fading transition concept 630. A transition concept is a method of displaying two or more transition images during the transition period between the display of slides. For example, the transition images may be displayed in an animated manner and/or the transition images may be displayed at a fixed location on the display. According to one embodiment, the transition concept that is selected is used in determining a resolution of the transition images. For instances, the resolution of the transition images in concept 610 may be the same for each image, whereas the resolution of the transition images in concept 630 may change from full resolution for transition image 5 to successively lower resolutions for the transition images behind transition image 5. Many other transition concepts may be utilized.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for transitioning between slides, comprising:
starting a presentation of slides that are within a presentation;
obtaining transition images; wherein the transition images comprise images of slides within the presentation;
receiving a transition indication of a transition between a display of a current slide and a next slide during the presentation;
selecting transition images to display during a transition period between the display of the current slide and the display of the next slide; wherein the transition images include images from at least two of the slides within the presentation; and
displaying the selected transition images during the transition period.

2. The method of claim 1, wherein obtaining the transition images comprising creating a transition image for each of the slides within the presentation.

3. The method of claim 1, further comprising caching a portion of the transition images.

4. The method of claim 3, further comprising caching at least some of the portion of the transition images at different resolutions.

5. The method of claim 4, wherein a resolution is selected for each of the portion of the transition images based on a display distance from the current slide.

6. The method of claim 3, wherein selecting the transition images comprises selecting at least one transition image of a slide before the current slide and at least another transition image of a slide after the current slide.

7. The method of claim 2, wherein caching the portion of the transition images comprises beginning caching at the current slide and then caching slides both in a forward display direction from the current slide and a backwards display direction from the current slide.

8. The method of claim 2, wherein displaying the selected transition images during the transition period comprises displaying the selected transition images according to a transition concept that provides an animation of the selected transition images.

9. A computer-readable storage medium having computer-executable instructions for displaying transition images of slides within a presentation during a transition period between a display of a current slide and a next slide, comprising:
receiving a transition indication of a transition between a display of the current slide and the next slide during the presentation;
selecting transition images to display during the transition period between the display of the current slide and the display of the next slide; wherein the selected transition images include images created from at least two of the slides within the presentation; wherein the transition images comprise a transition image for each of the slides within the presentation; and
displaying the selected transition images during the transition period.

10. The computer-readable storage medium of claim 9, further comprising caching a portion of the transition images.

11. The computer-readable storage medium of claim 10, further comprising caching at least some of the portion of the transition images at different resolutions.

12. The computer-readable storage medium of claim 11, wherein a resolution is selected for each of the portion of the transition images based on a display distance from the current slide.

13. The computer-readable storage medium of claim 9, wherein selecting the transition images comprises selecting at least one transition image of a slide before the current slide and at least another transition image of a slide after the next slide.

14. The computer-readable storage medium of claim 10, wherein caching the portion of the transition images comprises beginning caching in response to a presentation being selected and then caching transition images of slides in a forward display direction before caching previous transition images of previous slides.

15. (canceled)

16. The computer-readable storage medium of claim 10, further comprising re-sampling one or more of the cached transition images to a different resolution in response to a change in a current slide.

17. A system for displaying transition images during a presentation, comprising:
a processor and a computer-readable medium;
an input component configured to receive input;
a display configured to display images relating to a presentation;
a transition manager that is coupled to the input component and the display that is configured to perform actions using the processor comprising:
receiving a transition indication of a transition between a display of a current slide and a next slide during the presentation;
selecting transition images to display during the transition period between the display of the current slide and the display of the next slide;
wherein the transition images comprise a transition image for each of the slides within the presentation; wherein the transition images are cached; and
displaying the selected transition images during the transition period.

18. The system of claim 17, wherein at least some of the transition images are cached at different resolutions.

19. The system of claim 18, wherein selecting the transition images comprises selecting at least one transition image of a slide before the current slide and at least another transition image of a slide after the next slide.

20. The system of claim 17, further comprising re-sampling one or more of the cached transition images to a different resolution in response to a change in a current slide.

21. The system of claim 17, wherein selecting the transition images comprises selecting at least one transition image of a slide before the current slide and at least another transition image of a slide after the next slide.
